(19) United States
(12) Patent Application Publication
(10) Pub. No.: US 2026/0109257 A1
(43) Pub. Date: Apr. 23, 2026

(54) SYSTEMS AND METHODS FOR BI-DIRECTIONAL ONBOARD CHARGER FOR ELECTRIC VEHICLE

(71) Applicant: BorgWarner Inc., Auburn Hills, MI (US)

(72) Inventors: Sunil SREEDHAR, Westfield, IN (US); Alexandre M.S. REIS, Westfield, IN (US); Leonard TOMAJ, West Bloomfield, MI (US)

(73) Assignee: BorgWarner Inc., Auburn Hills, MI (US)

(21) Appl. No.: 18/919,629

(22) Filed: Oct. 18, 2024

(51) Int. Cl. B60L 55/00; B60L 53/16

(52) U.S. Cl. CPC B60L 55/00; B60L 53/16; B60L 2210/10; B60L 2210/30; B60L 2210/40

(57) ABSTRACT

A system includes a direct current to direct current (DC-DC) converter connected to a power factor correction (PFC) subsystem, wherein the PFC subsystem includes one or more leaves, wherein the one or more leaves of the PFC subsystem are operable to configure the PFC subsystem into each of a charging operation, a discharging operation, a split-phase operation, and a simultaneous charging and discharging operation.

### TECHNICAL FIELD

Various embodiments of the present disclosure relate generally to a power converter, and, more particularly, to a bi-directional onboard charger for simultaneous charging and discharging.

### BACKGROUND

Electric vehicles, for example, may include a charger to charge a battery of the electric vehicle. Electric vehicles may include an inverter to convert power from the battery to power for a system, such as a power outlet, of the vehicle. The charger and the inverter may not be operated simultaneously.

The present disclosure is directed to overcoming one or more of these above-referenced challenges.

### SUMMARY OF THE DISCLOSURE

In some aspects, the techniques described herein relate to a system for an on-board charger, the system including: a battery charger including: a direct current to direct current (DC-DC) converter connected to a power factor correction (PFC) subsystem, wherein the PFC subsystem includes one or more leaves, wherein the one or more leaves of the PFC subsystem are operable to configure the PFC subsystem into each of a charging operation, a discharging operation, a split-phase operation, and a simultaneous charging and discharging operation.

In some aspects, the techniques described herein relate to a system, wherein the on-board charger further includes: a neutral half bridge connected to the one or more leaves; a bypass relay connected to the one or more leaves and a power input; and an alternating current (AC) electromagnetic interference (EMI) filter connected between the one or more leaves and the bypass relay.

In some aspects, the techniques described herein relate to a system, wherein the one or more leaves include: a first leaf including a first inductor, a first upper switch, and a first lower switch, the first inductor connected to the first upper switch and the first lower switch; a second leaf including a second inductor, a second upper switch, and a second lower switch, the second inductor connected to the second upper switch and the second lower switch; a third leaf including a third inductor, a third upper switch, and a third lower switch, the third inductor connected to the third upper switch and the third lower switch; and a fourth leaf including a fourth inductor, a fourth upper switch, and a fourth lower switch, the fourth inductor connected to the fourth upper switch and the fourth lower switch.

In some aspects, the techniques described herein relate to a system, wherein the charging operation is configured to activate the first leaf and the second leaf, and turn off a bypass relay to charge a battery connected to a first power input, wherein each of the first leaf and the second leaf are configured at 90 degree phase shifts.

In some aspects, the techniques described herein relate to a system, wherein the charging operation includes a high power configuration operable to activate the first leaf, the second leaf, the third leaf, the fourth leaf, and turn on the bypass relay to charge the battery connected to the first power input, wherein the first leaf, the second leaf, the third leaf, and the fourth leaf are configured at 90 degree phase shifts, wherein the first leaf and the second leaf are connected in parallel and the third leaf and the fourth leaf are connected in parallel.

In some aspects, the techniques described herein relate to a system, wherein the discharging operation is configured to activate the first leaf and the second leaf, and turn off a bypass relay to output AC power received from the DC-DC converter through a first output, wherein each of the first leaf and the second leaf are configured at 90 degree phase shifts.

In some aspects, the techniques described herein relate to a system, wherein the discharging operation includes a high power configuration operable to activate the first leaf, the second leaf, the third leaf, the fourth leaf, and turn on the bypass relay to output AC power received from the DC-DC converter through the first output, wherein the first leaf, the second leaf, the third leaf, and the fourth leaf are configured at 90 degree phase shifts, wherein the first leaf and the second leaf are connected in parallel and the third leaf and the fourth leaf are connected in parallel.

In some aspects, the techniques described herein relate to a system, wherein the split-phase operation configured to activate the first leaf and the second leaf to output AC power received from the DC-DC converter at a first output voltage and a second output voltage, wherein the first leaf and the second leaf are out-of-phase.

In some aspects, the techniques described herein relate to a system, wherein the split-phase operation includes a high power configuration operable to activate the first leaf, the second leaf, the third leaf, and the fourth leaf to output AC power received from the DC-DC converter at the first output voltage and the second output voltage, wherein the first leaf and the second leaf are combined and the third leaf and the fourth leaf are combined, wherein the combined first leaf and the second leaf are connected in parallel and are out-of-phase with the combined third leaf and the fourth leaf connected in parallel.

In some aspects, the techniques described herein relate to a system, wherein the simultaneous charging and discharging operation is configured to: operate the first leaf and the second leaf to charge a battery connected to a first power input; and operate the third leaf and the fourth leaf to output AC power received from the DC-DC converter through a first output.

In some aspects, the techniques described herein relate to a system, further including: a battery connected to the DC-DC converter of the battery charger, and a motor configured to rotate based on power received from the battery, wherein the system is provided as a vehicle.

In some aspects, the techniques described herein relate to a system, wherein the battery charger is configured to: receive input AC power through the PFC subsystem, convert the AC power to DC power, and provide the DC power to the battery to charge the battery, and receive DC power from the battery through the DC-DC converter, convert the DC power to AC power, and provide the AC power through the PFC subsystem as output AC power.

In some aspects, the techniques described herein relate to a system for a power factor correction (PFC) subsystem, the system including: a first leaf including a first inductor, a first upper switch, and a first lower switch, the first inductor connected to the first upper switch and the first lower switch; and a second leaf including a second inductor, a second upper switch, and a second lower switch, the second inductor connected to the second upper switch and the second lower switch; wherein the first leaf and the second leaf are connected to one or more AC EMI filters, a bypass relay, and one or more inputs.

In some aspects, the techniques described herein relate to a system, further including: a third leaf including a third inductor, a third upper switch, and a third lower switch, the third inductor connected to the third upper switch and the third lower switch; and a fourth leaf including a fourth inductor, a fourth upper switch, and a fourth lower switch, the fourth inductor connected to the fourth upper switch and the fourth lower switch, wherein the third leaf and the fourth leaf are connected to the one more AC EMI filters and the one or more inputs.

In some aspects, the techniques described herein relate to a system, wherein the first leaf and the second leaf are operable to configure the PFC subsystem into each of a charging operation, a discharging operation, a split-phase operation, and a simultaneous charging and discharging operation.

In some aspects, the techniques described herein relate to a system, wherein the charging operation is configured to charge a battery connected to a first input, wherein the discharging operation is configured to output AC power through a first output, wherein the split-phase operation is configured to output AC power at a first output voltage and a second output voltage, and wherein the simultaneous charging and discharging operation is configured to charge the battery connected to the first input and output AC power through the first output.

In some aspects, the techniques described herein relate to a method including: operating a first leaf and a second leaf of a PFC subsystem to perform a charging operation, wherein the charging operation is configured to charge a battery connected to a DC-DC converter; operating the first leaf and the second leaf of the PFC subsystem to perform a discharging operation, wherein the discharging operation is configured to output AC power received from the DC-DC converter; operating the first leaf and the second leaf of the PFC subsystem to perform a split-phase operation, wherein the split-phase operation is configured to output out-of-phase AC power received from the DC-DC converter; and operating the first leaf, the second leaf, a third leaf, and a fourth leaf of the PFC subsystem to perform a simultaneous charging and discharging operation, wherein the simultaneous charging and discharging operation is configured to charge a battery connected to the DC-DC converter and output AC power received from the DC-DC converter.

In some aspects, the techniques described herein relate to a method, wherein the charging operation further includes activating the first leaf and the second leaf, and turning off a bypass relay to charge the battery connected to a first power input, wherein each of the first leaf and the second leaf are configured at 90 degree phase shifts, wherein the discharging operation further includes activating the first leaf and the second leaf, and turn off the bypass relay to output AC power received from the DC-DC converter through a first output, wherein each of the first leaf and the second leaf are configured at 90 degree phase shifts, wherein the split-phase operation further includes activating the first leaf and the second leaf to output the AC power received from the DC-DC converter at a first output voltage and a second output voltage, wherein the first leaf and the second leaf are out-of-phase, and wherein the simultaneous charging and discharging operation further includes operating the first leaf and the second leaf to charge the battery connected to the first power input and operate the third leaf and the fourth leaf to output the AC power received from the DC-DC converter through the first output.

In some aspects, the techniques described herein relate to a method, wherein the charging operation further includes operating the third leaf, the fourth leaf, and turning on the bypass relay to charge the battery connected to the first power input, wherein the first leaf, the second leaf, the third leaf, and the fourth leaf are configured at 90 degree phase shifts, wherein the first leaf and the second leaf are connected in parallel and the third leaf and the fourth leaf are connected in parallel.

In some aspects, the techniques described herein relate to a method, wherein the discharging operation further includes operating the third leaf, the fourth leaf, and turning on the bypass relay to output AC power received from the DC-DC converter through a first output, wherein the first leaf, the second leaf, the third leaf, and the fourth leaf are configured at 90 degree phase shifts, wherein the first leaf and the second leaf are connected in parallel and the third leaf and the fourth leaf are connected in parallel.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure for a vehicle including a combined bi-directional and split-phase converter, according to one or more embodiments.

FIG. 2 depicts an exemplary system infrastructure for a battery charger, according to one or more embodiments.

FIG. 3 depicts an implementation of a computer system that may execute techniques presented herein, according to one or more embodiments.

FIG. 4 depicts an exemplary electrical schematic for a battery charger with a lower power requirement, according to one or more embodiments.

FIG. 5 depicts an exemplary electrical schematic for a battery charger with a higher power requirement, according to one or more embodiments.

FIG. 6 depicts an exemplary simulation result of a split phase operation of a battery charger, according to one or more embodiments.

FIG. 7 depicts an exemplary simulation result of a simultaneous charging and discharging operation of the battery charger, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

Various embodiments of the present disclosure relate generally to a power converter, and, more particularly, to a bi-directional onboard charger for simultaneous charging and discharging.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Electric vehicles (EV) are becoming more popular with prices of fuel going up and standards for fuel emissions becoming stricter. Besides using EVs as vehicles, other applications are emerging such as energy storage and backup generators. The on-board charger (OBC) may have a dual purpose. The purpose of the bidirectional system may include converting AC to DC voltage in charging mode and DC to AC in discharge or inverter mode. Charge mode may be used to convert grid AC into DC voltage to charge the vehicle's high voltage (HV) battery. Discharge or inverter mode converts the HV battery DC voltage into AC voltage that may go back to the grid, be supplied as a back generator to power a house when the grid is down, or as an inverter to supply voltage to the vehicle's AC outlets, for example.

The ability of the OBC to supply different loads along with performing the bi-directional power conversion may be an attractive option for automotive companies to reduce cost and space needed for different components in the vehicle. The ability to simultaneously charge and discharge may be an attractive option that may allow an EV to charge its HV battery and generate AC at different voltage levels, such as 120 Vrms and 240 Vrms.

This design may create more options for power conversion by fully utilizing the power stages of the OBC to perform (1) OBC charging operation (e.g., charging HV battery), (2) OBC discharging operation (e.g., supplying AV power to loads/grids), (3) split-phase inverter operation (e.g., supply split-phase power to loads/home/grids), and (4) simultaneously charging and discharging operations. This design may combine the charging, discharging, and split-phase inverter products into the same hardware with the option of performing charging and discharging operation at the same time. The combined converter approach may reduce the component count, increase power density, and reduce overall product size needed to perform all four operations. The Power Factor Correction (PFC) subsystem contains four PFC leaves, one Neutral half bridge, a bypass relay, and an AC Electromagnetic Interference (EMI) filter. The PFC hardware may be operated to achieve all power conversion options while maintaining the same DC/DC converter section.

During the OBC charging only operation, high power and better EMI performance may be achieved by utilizing the four PFC leaves and turning ON the bypass relay. This may allow for increased utilization of the product hardware. The four PFC leaves may be switched at 90 degree phase shifts, allowing for more efficient ripple cancellation and reducing EMI noise. If lower power is needed, the bypass relay may be turned off and two PFC leaves may be operated to achieve higher efficiency, while maintaining good EMI performance due to ripple cancellation of the out-of-phase switching Pulse Width Modulation (PWM). Utilizing the bypass relay, the four PFC leaves may be operated in pairs to distribute the power during lower power operation and equalize the utilization of the PFC leaves during the lifetime of the product.

During the OBC discharging only operation, high power and better EMI performance may be achieved by utilizing the four PFC leaves and turning ON the bypass relay. This may allow for increased utilization of the product hardware. The four PFC leaves may be switched at 90 degree phase shifts, allowing for more efficient ripple cancellation and reducing EMI noise. If lower power is needed, the bypass relay may be turned off and two PFC leaves can be operated to achieve higher efficiency and still have good EMI performance due to ripple cancellation of the out-of-phase switching PWM. Utilizing the bypass relay, the four PFC leaves may be operated in pairs to distribute the power during lower power operation and equalize the utilization of the PFC leaves during the lifetime of the product. In addition, the OBC discharging output may be generated at two different connector locations on the product thus reducing the wiring needed in the vehicle.

During the split-phase inverter only operation, two PFC leaves may be used to generate the out-of-phase AC output voltages which may be operated simultaneously to power a split-phase load or in unbalanced mode to power a split-phase load and a single-phase load. If split-phase inverter operation requires more power, PFC leaf 1 may be combined with PFC leaf 2 and PFC leaf 3 may be combined with PFC leaf 4. The additional leaves may also help with reducing EMI noise by operating them with out-of-phase PWMs.

During the OBC charging and discharging simultaneous operation, two PFC leaves may be used for charging operation to charge the HV battery from the AC grid and two PFC leaves may be used to power AC single phase loads. The simultaneous operation ensures full utilization of hardware and reduces the amount of neutral current in the neutral half bridge of the PFC, hence reducing overall losses.

By maximizing the PFC utilization, the high voltage DC-DC converter of the OBC may be designed for rated power of the product and the PFC subsystem may provide the flexibility to perform different power conversion options.

The input and output layout of the charger may follow automotive standards. A battery charger according to the disclosure may include a two-stage configuration, including an AC-DC power factor correction converter stage and an isolated DC-DC converter stage. The isolated DC-DC converter may include a half-bridge or a full-bridge driver configuration with resonant tank elements to achieve better efficiency. The DC-DC converter may be designed to charge the battery back from minimum voltage to maximum voltage.

The converter may receive power from an AC power source and provide DC power to a battery, or receive power from the battery and provide power as an AC power source. A vehicle to grid (V2G) operation may be achieved with a designed control strategy for single-phase and two-phase systems. The switches may be any devices, such as GTO, thyristors, or MOSFETs/IGBTs with series diodes, for example. These switches may also be mechanical components (such as relays or contactors) if sufficient failure rates and arcing conditions during operation are met.

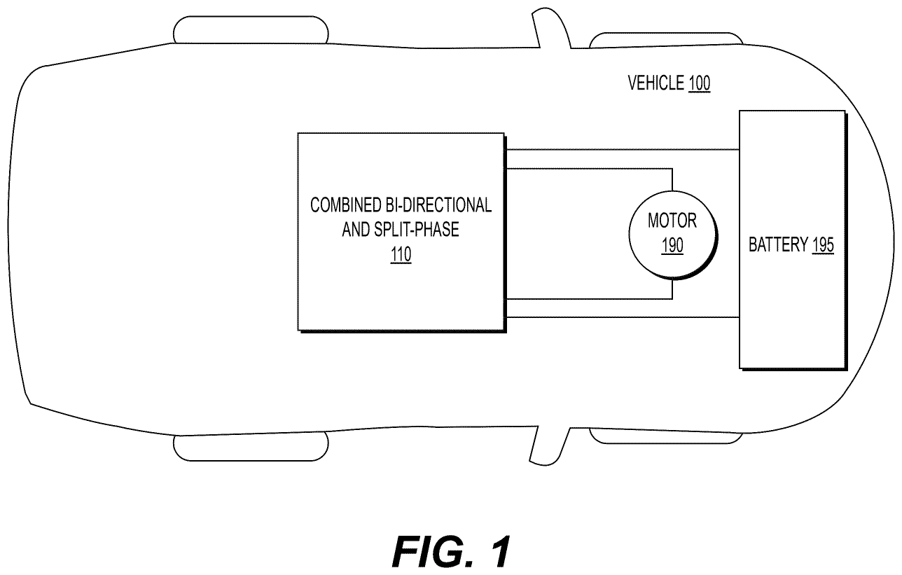

FIG. 1 depicts an exemplary system infrastructure for a vehicle including a combined inverter and converter, according to one or more embodiments. In the context of this disclosure, the combined inverter and converter may be referred to as an inverter. As shown in FIG. 1, electric vehicle 100 may include a battery charger 110, a motor 190, and a battery pack 195. The battery charger 110 may include components to receive electrical power from an external source and output electrical power to charge battery pack 195 of electric vehicle 100. The battery charger 110 may convert DC power from battery pack 195 in electric vehicle 100 to AC power, to drive motor 190 of the electric vehicle 100, for example, but the embodiments are not limited thereto. The battery charger 110 may be bidirectional, and may convert DC power to AC power, or convert AC power to DC power, such as during regenerative braking, for example. Battery charger 110 may be a single-phase inverter or a multi-phase inverter.

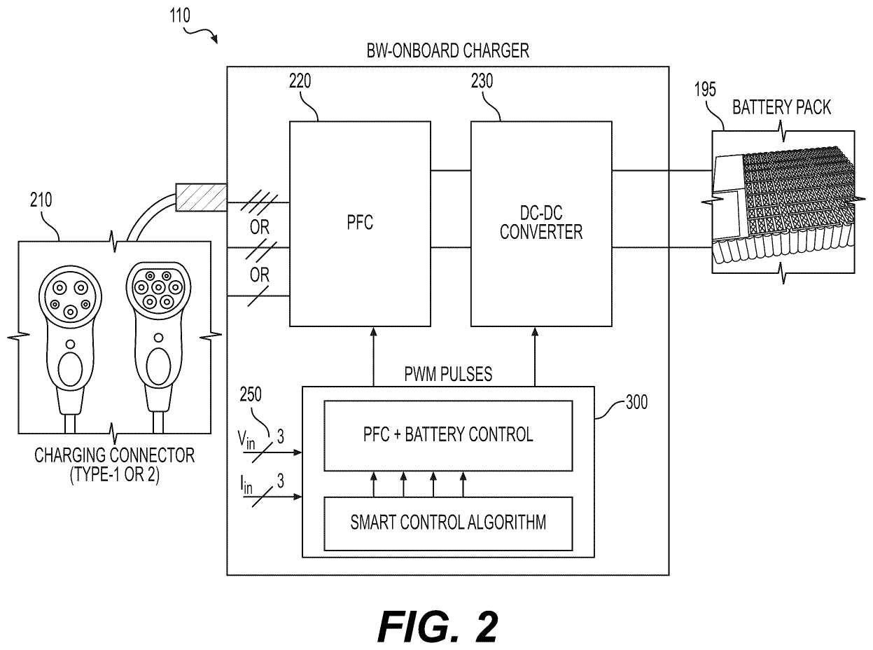

FIG. 2 depicts an exemplary system infrastructure for a battery charger with a DC-DC converter, according to one or more embodiments. As shown in FIG. 2, a battery charger 110 may include or be electrically connectable to a charging connector 210. The charging connector 210 may provide an electrical connection from an external power supply to the battery charger 110, and may be a Type 1 or a Type 2 connector, for example. The charging connector 210 may transfer single phase or two-phase power.

The battery charger 110 may include a PFC subsystem 220, a DC-DC converter 230, and a controller 300 receiving signals from input sensor 250. The battery charger 110 may include or be electrically connectable to a battery pack 195. The battery charger 110 may be used in automotive vehicles as an onboard charger to transfer power from an external power source through charging connector 210 to battery pack 195, or to transfer power from battery pack 195 in a vehicle to grid operation. The battery charger 110 may be included in a system provided as an electric vehicle including a motor configured to rotate based on power received from the battery pack 195.

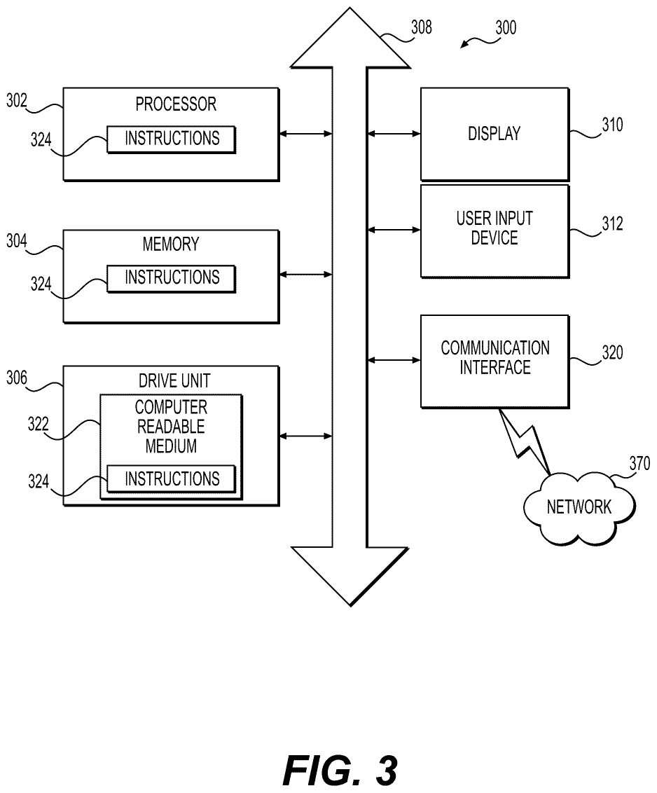

FIG. 3 depicts an implementation of a controller 300 that may execute techniques presented herein, according to one or more embodiments.

Any suitable system infrastructure may be put into place to allow control of the battery charger. FIG. 3 and the following discussion provide a brief, general description of a suitable computing environment in which the present disclosure may be implemented. In one embodiment, any of the disclosed systems, methods, and/or graphical user interfaces may be executed by or implemented by a computing system consistent with or similar to that depicted in FIG. 3. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

The controller 300 may include a set of instructions that can be executed to cause the controller 300 to perform any one or more of the methods or computer-based functions disclosed herein. The controller 300 may operate as a standalone device or may be connected, e.g., using a network, to other computer systems or peripheral devices.

In a networked deployment, the controller 300 may operate in the capacity of a server or as a client in a server-client user network environment, or as a peer computer system in a peer-to-peer (or distributed) network environment. The controller 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 300 can be implemented using electronic devices that provide voice, video, or data communication. Further, while the controller 300 is illustrated as a single system, the term “system” shall also be taken to include any collection of systems or sub-systems that individually or jointly execute a set, or multiple sets, of instructions to perform one or more computer functions.

As illustrated in FIG. 3, the controller 300 may include a processor 302, e.g., a central processing unit (CPU), a graphics processing unit (GPU), or both. The processor 302 may be a component in a variety of systems. For example, the processor 302 may be part of a standard computer. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The controller 300 may include a memory 304 that can communicate via a bus 308. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 304 includes a cache or random-access memory for the processor 302. In alternative implementations, the memory 304 is separate from the processor 302, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the processor 302 executing the instructions stored in the memory 304. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the controller 300 may further include a display 310, such as a liquid crystal display (LCD), an organic light emitting diode (OLED), a flat panel display, a solid-state display, a cathode ray tube (CRT), a projector, a printer or other now known or later developed display device for outputting determined information. The display 310 may act as an interface for the user to see the functioning of the processor 302, or specifically as an interface with the software stored in the memory 304 or in the drive unit 306.

Additionally or alternatively, the controller 300 may include an input device 312 configured to allow a user to interact with any of the components of controller 300. The input device 312 may be a number pad, a keyboard, or a cursor control device, such as a mouse, or a joystick, touch screen display, remote control, or any other device operative to interact with the controller 300.

The controller 300 may also or alternatively include drive unit 306 implemented as a disk or optical drive. The drive unit 306 may include a computer-readable medium 322 in which one or more sets of instructions 324, e.g. software, can be embedded. Further, the instructions 324 may embody one or more of the methods or logic as described herein. The instructions 324 may reside completely or partially within the memory 304 and/or within the processor 302 during execution by the controller 300. The memory 304 and the processor 302 also may include computer-readable media as discussed above.

In some systems, a computer-readable medium 322 includes instructions 324 or receives and executes instructions 324 responsive to a propagated signal so that a device connected to a network 370 can communicate voice, video, audio, images, or any other data over the network 370. Further, the instructions 324 may be transmitted or received over the network 370 via a communication port or interface 320, and/or using a bus 308. The communication port or interface 320 may be a part of the processor 302 or may be a separate component. The communication port or interface 320 may be created in software or may be a physical connection in hardware. The communication port or interface 320 may be configured to connect with a network 370, external media, the display 310, or any other components in controller 300, or combinations thereof. The connection with the network 370 may be a physical connection, such as a wired Ethernet connection or may be established wirelessly as discussed below. Likewise, the additional connections with other components of the controller 300 may be physical connections or may be established wirelessly. The network 370 may alternatively be directly connected to a bus 308.

While the computer-readable medium 322 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 322 may be non-transitory, and may be tangible.

The computer-readable medium 322 can include a solid-state memory such as a memory card or other package that houses one or more non-volatile read-only memories. The computer-readable medium 322 can be a random-access memory or other volatile re-writable memory. Additionally or alternatively, the computer-readable medium 322 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 300 may be connected to a network 370. The network 370 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 370 may include wide area networks (WAN), such as the Internet, local area networks (LAN), campus area networks, metropolitan area networks, a direct connection such as through a Universal Serial Bus (USB) port, or any other networks that may allow for data communication. The network 370 may be configured to couple one computing device to another computing device to enable communication of data between the devices. The network 370 may generally be enabled to employ any form of machine-readable media for communicating information from one device to another. The network 370 may include communication methods by which information may travel between computing devices. The network 370 may be divided into sub-networks. The sub-networks may allow access to all of the other components connected thereto or the sub-networks may restrict access between the components. The network 370 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

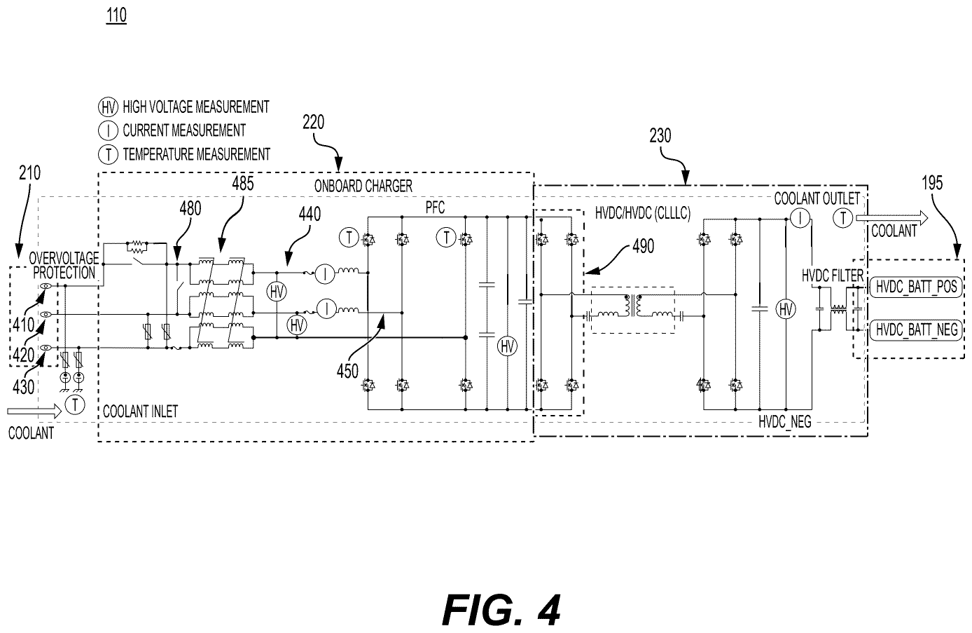

FIG. 4 depicts an exemplary electrical schematic for a battery charger with a lower power requirement, according to one or more embodiments. As shown in FIG. 4, the battery charger 110 may include the charging connector 210, the PFC subsystem 220, the DC-DC converter 230, and the battery pack 195 as discussed above with respect to FIG. 2. The charging connector 210 may include a first connector 410, a second connector 420, and a third connector 430 connecting the charging connector 210 to the PFC subsystem 220. The PFC subsystem 220 may perform operations of charging only, discharging only, split-phase, and simultaneous charging and discharging. During charging only, the first connector 410 may receive power (e.g., AC power) from an outside energy source to be provided to the PFC subsystem 220. During discharging only, the first connector 410 may not be used and the second connector 420 may receive converted AC power from the DC-DC converter 230 for output back to the grid or as a backup generator for a home. In addition, the second connector 420 may be used as an AC power outlet for the vehicles power outlets. During split-phase operation, the first connector 410 and the second connector 420 are both used as outputs. During simultaneous charging and discharging, the first connector 410 may receive power from an outside energy source to be provided to the PFC subsystem 220, and the second connector 420 may receive converted AC power from the DC-DC converter 230 for output. The third connector 430 may be a neutral ground for the first connector 410 and/or the second connector 420 during any of the operations as described above.

The PFC subsystem 220 may include a first leaf 440, a second leaf 450, a bypass relay 480, and an AC EMI filter 485. The bypass relay 480 may be connected between the first connector and configured in the ON or OFF position depending on the application. For example, the bypass relay 480 may be turned OFF during a low power or standard power operation. The bypass relay 480 may be turned ON during high power applications. The use of the bypass relay 480 and the AC EMI filter 485 may be advantageous during a high power application to increase the noise filtering of the AC EMI filter 485.

The first leaf 440 may include an inductor and one or more switches (e.g., upper switch and lower switch). The second leaf 450 may include an inductor and one or more switches (e.g., upper switch and lower switch). The first leaf 440 and the second leaf 450 may connect the PFC subsystem 220 to the DC-DC converter 230 through bridge 490. The first leaf 440 and the second leaf 450 may be operated by a pulse width modulation (PWM) (not shown) via controller 300 at the same or different phase shifts.

The PFC subsystem 220 may be configured to operate in a charging only operation, a discharging only operation, a split-phase operation, and a simultaneous charging and discharging operation. According to an embodiment, the PFC subsystem 220 may be configured in the charging only operation and may charge the battery pack 195. The PFC subsystem 220 may receive input power (e.g., AC power) through the first connector 410 and use the third connector 430 as a neutral connection. The first leaf 440 and the second leaf 450 may be switched at 90 degree phase shifts allowing for more efficient ripple cancellation and reduction in EMI noise. The bypass relay 480 may be configured to be turned ON or OFF depending on the power requirements or parameters of the application. The bypass relay 480 may be configured in the OFF position for standard or low power applications, and alternatively, the bypass relay 480 may be configured in the ON position for high power applications. The input power received at the first connector 410 may be provided through the first leaf 440 and the second leaf 450 to the bridge 490 and the DC-DC converter 230. The DC-DC converter 230 may be configured to convert the input power (e.g., AC power) to DC voltages for charging the battery pack 195.

According to an embodiment, the PFC subsystem 220 may be configured in the discharging only operation and may provide AC power back to the grid, a backup generator, or the like. The Battery pack 195 may provide DC voltage to the DC-DC converter 230 where the DC-DC converter 230 may convert the DC voltage to AC voltage and may be provided to the PFC subsystem 220. As similarly described above, the first leaf 440 and the second leaf 450 may be switched at 90 degree phase shifts allowing for more efficient ripple cancellation and reduction in EMI noise. The bypass relay 480 may be configured to be turned ON or OFF depending on the power requirements or parameters of the application. The bypass relay 480 may be configured in the OFF position for standard or low power applications, and alternatively, the bypass relay 480 may be configured in the ON position for high power applications. The AC voltage received from the DC-DC converter 230 may be output through the second connector 420 for use by the grid, backup generator, or the like. The battery charger 110 may include two different connector locations (e.g., first connector 410 and second connector 420, with respect to third connector 430 as a neutral connection) to reduce the wiring requirements in a vehicle.

According to an embodiment, the PFC subsystem 220 may be configured in the split-phase operation and may provide out-of-phase AC output voltages to power a split-phase load. As similarly described in the discharging only operation, the battery pack 195 may provide DC voltage to the DC-DC converter 230 where the DC-DC converter 230 may convert the DC voltage to AC voltage and may be provided to the PFC subsystem 220. The first leaf 440 and the second leaf 450 may be switched at 90 degrees out-of-phase shifts from one another. The bypass relay 480 may be configured to be turned ON or OFF depending on the power requirements or parameters of the application. The bypass relay 480 may be configured in the OFF position for standard or low power applications, and alternatively, the bypass relay 480 may be configured in the ON position for high power applications. The AC voltage generated by the PFC subsystem 220 using the energy received from the DC-DC converter 230 may be split-phase and output on the first connector 410 and the second connector 420 for use by the grid, backup generator, or the like, with respect to the third connector 430 as a neutral connection.

According to an embodiment, the PFC subsystem 220 may be configured in the simultaneous charging and discharging operation and may charge the battery pack 195 and may provide AC power back to the grid, a backup generator, or the like at the same time. As similarly described above, the PFC subsystem 220 may receive input power (e.g., AC power) through the first connector 410. The first leaf 440 and the second leaf 450 may be switched at 90 degree phase shifts allowing for more efficient ripple cancellation and reduction in EMI noise. The bypass relay 480 may be configured to be turned ON or OFF depending on the power requirements or parameters of the application. The bypass relay 480 may be configured in the OFF position for standard or low power applications, and alternatively, the bypass relay 480 may be configured in the ON position for high power applications. The input power received at the first connector 410 may be provided through the first leaf 440 or the second leaf 450 to the bridge 490 and the DC-DC converter 230. The DC-DC converter 230 may be configured to convert the input power (e.g., AC power) to DC voltages for charging the battery pack 195. At the same time, the battery pack 195 may provide DC voltage to the DC-DC converter 230 where the DC-DC converter 230 may convert the DC voltage to AC voltage and may be provided to the PFC subsystem 220 through the first leaf 440 or the second leaf 450. The AC voltage generated by the PFC subsystem 220 using the energy received from the DC-DC converter 230 may be output through the second connector 420 for use by the grid, backup generator, or the like. The battery charger 110 may include two different connector locations (e.g., first connector 410 and second connector 420, with respect to third connector 430 as a neutral connection) to reduce the wiring requirements in a vehicle.

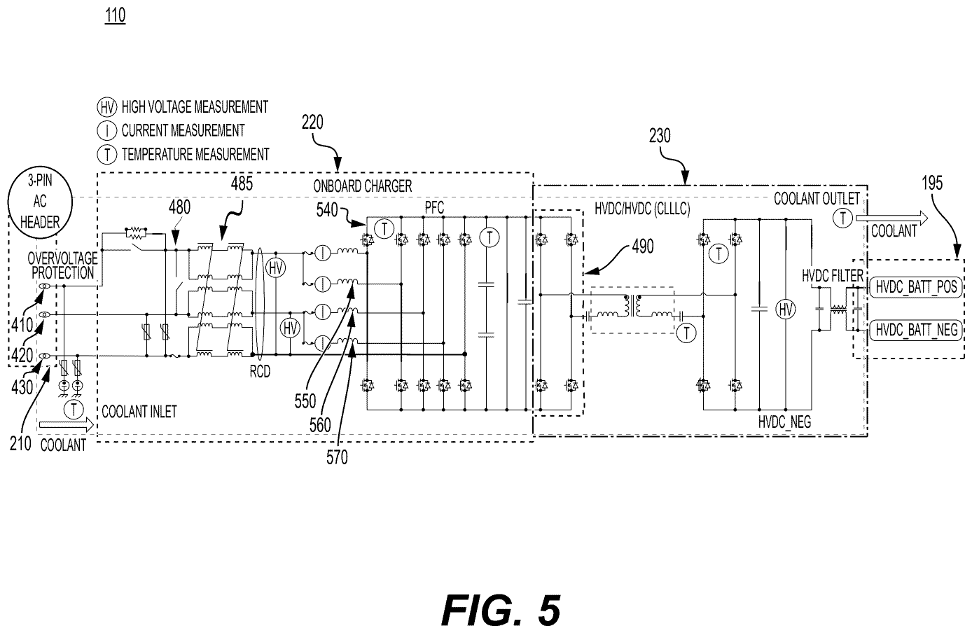

FIG. 5 depicts an exemplary electrical schematic for a battery charger with a higher power requirement, according to one or more embodiments. The battery charger 110 may be configured and operable similar to the battery charger 110 shown and described above with respect to FIG. 4 except as otherwise described herein. As such, like reference numerals are used to identify similar components.

The PFC subsystem 220 may include a first leaf 540, a second leaf 550, a third leaf 560, a fourth leaf 570, a bypass relay 480, and an AC EMI filter 485. The bypass relay 480 may be connected between the first connector 410 tuned ON or OFF depending on the application. For example, the bypass relay 480 may be turned OFF during a low power or standard power operation. The bypass relay 480 may be turned ON during high power applications. The use of the bypass relay 480 and the AC EMI filter 485 may be advantageous during a high power application to increase the noise filtering of the AC EMI filter 485. The use of the first leaf 540, the second leaf 550, the third leaf 560, and the fourth leaf 570 may increase the power operation, the efficiency, the noise reduction, or a combination thereof.

The first leaf 540 may include an inductor and one or more switches (e.g., upper switch and lower switch). The second leaf 550 may include an inductor and one or more switches (e.g., upper switch and lower switch). The third leaf 560 may include an inductor and one or more switches (e.g., upper switch and lower switch). The fourth leaf 570 may include an inductor and one or more switches (e.g., upper switch and lower switch). The first leaf 540, the second leaf 550, the third leaf 560, and the fourth leaf 570 may connect the PFC subsystem 220 to the DC-DC converter 230 through bridge 490. The first leaf 540, the second leaf 550, the third leaf 560, and the fourth leaf 570 may be operated by a PWM (not shown) at the same or different phase shifts.

The PFC subsystem 220 may be configured to operate in a charging only operation, a discharging only operation, a split-phase operation, and a simultaneous charging and discharging operation. According to an embodiment, the PFC subsystem 220 may be configured in the charging only operation and may charge the battery pack 195. The PFC subsystem 220 may receive input power (e.g., AC power) through the first connector 410 and use the third connector as a neutral connection. The first leaf 540, the second leaf 550, the third leaf 560, and the fourth leaf 570 may be switched at 90 degree phase shifts allowing for more efficient ripple cancellation and reduction in EMI noise. The first leaf 540 and the second leaf 550 may be connected in parallel and the third leaf 560 and the fourth leaf 570 may be connected in parallel. The bypass relay 480 may be configured to be turned ON or OFF depending on the power requirements or parameters of the application. The bypass relay 480 may be configured in the ON position for high power applications. The input power received at the first connector 410 may be provided through the first leaf 540, the second leaf 550, the third leaf 560, and the fourth leaf 570 to the bridge 490 and the DC-DC converter 230. The DC-DC converter 230 may be configured to convert the input power (e.g., AC power) to DC voltages for charging the battery pack 195.

According to an embodiment, the PFC subsystem 220 may be configured in the discharging only operation and may provide AC power back to the grid, a backup generator, or the like. The Battery pack 195 may provide DC voltage to the DC-DC converter 230 where the DC-DC converter 230 may convert the DC voltage to AC voltage and may be provided to the PFC subsystem 220. As similarly described above, the first leaf 540, the second leaf 550, the third leaf 560, and the fourth leaf 570 may be switched at 90 degree phase shifts allowing for more efficient ripple cancellation and reduction in EMI noise. The first leaf 540 and the second leaf 550 may be connected in parallel and the third leaf 560 and the fourth leaf 570 may be connected in parallel. The bypass relay 480 may be configured to be turned ON or OFF depending on the power requirements or parameters of the application. The bypass relay 480 may be configured in the ON position for high power applications. The AC voltage received from the DC-DC converter 230 may be output through the second connector 420 for use by the grid, backup generator, or the like. The battery charger 110 may include two different connector locations (e.g., first connector 410 and second connector 420, with respect to the third connector 430 as a neutral connection) to reduce the wiring requirements in a vehicle.

According to an embodiment, the PFC subsystem 220 may be configured in the split-phase operation and may provide out-of-phase AC output voltages which may be operated simultaneously to power a split-phase load or in unbalanced mode to power a split-phase load and a single phase load. As similarly described in the discharging only operation, the battery pack 195 may provide DC voltage to the DC-DC converter 230 where the DC-DC converter 230 may convert the DC voltage to AC voltage and may be provided to the PFC subsystem 220. In the split-phase configuration, the first leaf 540 and the second leaf 550 may be connected in parallel and the third leaf 560 and the fourth leaf 570 may be connected in parallel. The first leaf 440 and the second leaf 450 may be switched at 90 degrees out-of-phase shifts from the third leaf 560 and the fourth leaf 570. The bypass relay 480 may be configured to be turned ON or OFF depending on the power requirements or parameters of the application. The bypass relay 480 may be configured in the ON position for high power applications. The AC voltage generated by the PFC subsystem 220 using the energy received from the DC-DC converter 230 may be split-phase and output on the first connector 410 and the second connector 420 for use by the grid, backup generator, or the like, with respect to the third connector 430 as a neutral connection.

In the unbalanced mode, the first leaf 540 may be configured to be operated alone or in parallel with the second leaf 550 and the third leaf 560 may be configured to be operated along or in parallel with the fourth leaf 570. The unbalanced mode may utilize three of the four leaves. For example, the first leaf 540 and the second leaf 550 may be connected in parallel and operated at a 90 degree out-of-phase from the third leaf 560. The AC voltage generated by the PFC subsystem 220 using energy received from the DC-DC converter 230 may be split between the first connector 410 and the second connector 420 with respect to the third connector 430 as a neutral connection. In unbalanced mode, AC current may be provided. The unbalanced mode may generate the same voltage with different currents at the first connector 410 and the second connector 420 with respect to the third connector 430 as a neutral connection. Stated differently, unbalanced mode may include different loads to be connected to each of the split-phase outputs (e.g., first connector 410 and second connector 420). The PFC subsystem 220 may handle unbalanced loads on each of the split-phase outputs and the unbalanced current flows through the neutral connection (e.g., third connector 430). Unbalanced mode may generate out of phase voltages and manage unbalanced current through each line of the split-phase output (e.g., first connector 410 and second connector 420).

According to an embodiment, the PFC subsystem 220 may be configured in the simultaneous charging and discharging operation and may charge the battery pack 195 and may provide AC power back to the grid, a backup generator, or the like at the same time. As similarly described above, the PFC subsystem 220 may receive input power (e.g., AC power) through the first connector 410. The first leaf 540, the second leaf 550, the third leaf 560, and the fourth leaf 570 may be switched at 90 degree phase shifts allowing for more efficient ripple cancellation and reduction in EMI noise. The first leaf 540 and the second leaf 550 may be connected in parallel and the third leaf 560 and the fourth leaf 570 may be connected in parallel. The bypass relay 480 may be configured to be turned ON or OFF depending on the power requirements or parameters of the application. The bypass relay 480 may be configured in the ON position for high power applications. The input power received at the first connector 410 may be provided through the first leaf 440 and the second leaf 450 connected in parallel to the bridge 490 and the DC-DC converter 230. The DC-DC converter 230 may be configured to convert the input power (e.g., AC power) to DC voltages for charging the battery pack 195. At the same time, the battery pack 195 may provide DC voltage to the DC-DC converter 230 where the DC-DC converter 230 may convert the DC voltage to AC voltage and may be provided to the PFC subsystem 220 through the third leaf 560 and the fourth leaf 570 connected in parallel. The AC voltage generated by the PFC subsystem 220 using the energy received from the DC-DC converter 230 may be output through the second connector 420 for use by the grid, backup generator, or the like. The battery charger 110 may include two different connector locations (e.g., first connector 410 and second connector 420, with respect to the third connector 430 as a neutral connection) to reduce the wiring requirements in a vehicle.

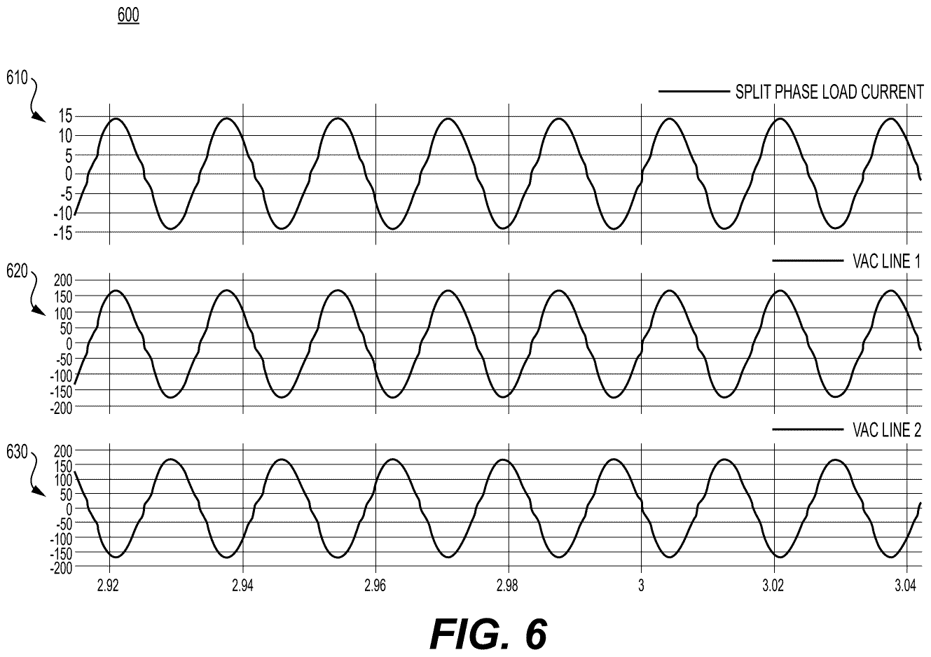

FIG. 6 depicts an exemplary simulation result of the split-phase operation, according to one or more embodiments. Split-phase simulation 600 may include split-phase output current 610, first AC output voltage 620, and second AC output voltage 630. As described with respect to FIG. 4 above in the split-phase operation, the battery pack 195 may provide DC voltage to the DC-DC converter 230 where the DC-DC converter 230 may convert the DC voltage to AC voltage and may be provided to the PFC subsystem 220. The first leaf 440 and the second leaf 450 may be switched at 90 degrees out-of-phase shifts from one another. The AC voltage (e.g., the split-phase output current 610) received from the DC-DC converter 230 may be split-phase and output between the first connector 410 for use by the grid, backup generator, or the like, and the second connector 420, with respect to the third connector 430 as a neutral connection, for use by the AC outlets of the vehicle. For example, the AC voltage generation may include the first connector 410 outputting 120V (e.g., the first AC output voltage 620) and the second connector 420 outputting (-) 120V (e.g., the second AC output voltage 630), where the load is applied across both the first connector 410 and the second connector 420. Split-phase operation may increase power by activating more leaves (e.g., third leaf 560 and fourth leaf 570) as similarly described with respect to FIG. 5 above.

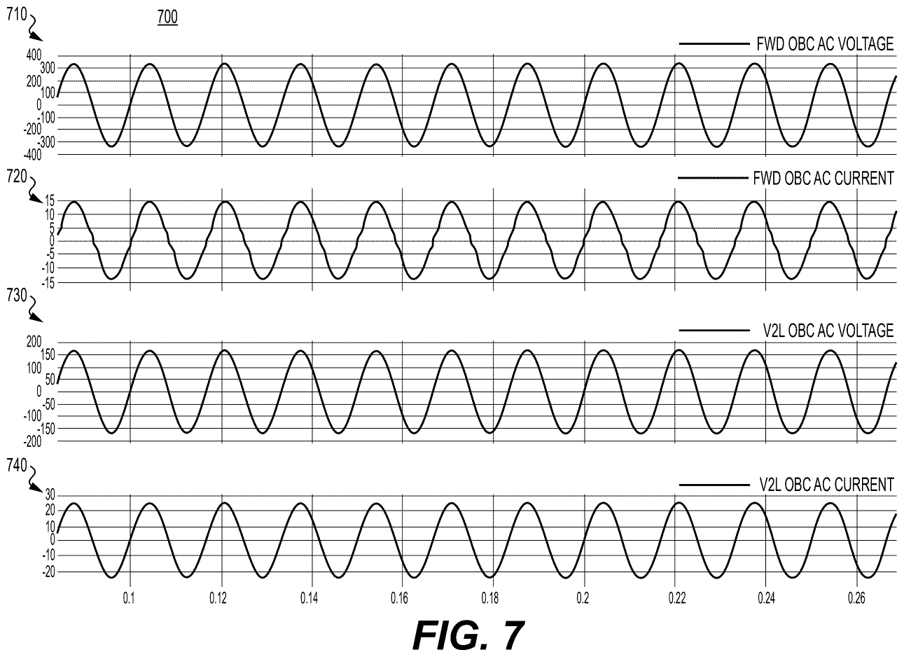

FIG. 7 depicts an exemplary simulation result of the simultaneously charging and discharging operation, according to one or more embodiments. Simultaneous charging and discharging simulation 700 may include an OBC AC voltage 710, and OBC AC current 720, a V2L AC voltage 730, and a V2L AC current 740. As described with respect to FIG. 5 above in the simultaneous charging and discharging operation, the PFC subsystem 220 may receive input power (e.g., AC power) through the first connector 410. The first leaf 540, the second leaf 550, the third leaf 560, and the fourth leaf 570 may be switched at 90 degree phase shifts allowing for more efficient ripple cancellation and reduction in EMI noise. The first leaf 540 and the second leaf 550 may be connected in parallel and the third leaf 560 and the fourth leaf 570 may be connected in parallel. The bypass relay 480 may be configured to be turned ON or OFF depending on the power requirements or parameters of the application. The input power received at the first connector 410 may be provided through the first leaf 440 and the second leaf 450 connected in parallel to the bridge 490 and the DC-DC converter 230. The DC-DC converter 230 may be configured to convert the input power (e.g., AC power) to DC voltages for charging the battery pack 195. At the same time, the battery pack 195 may provide DC voltage to the DC-DC converter 230 where the DC-DC converter 230 may convert the DC voltage to AC voltage and may be provided to the PFC subsystem 220 through the third leaf 560 and the fourth leaf 570 connected in parallel. The AC voltage received from the DC-DC converter 230 may be output through the second connector 420 for use by the grid, backup generator, or the like. The battery charger 110 may include two different connector locations (e.g., first connector 410 and second connector 420, with respect to the third connector 430 as a neutral connection) to reduce the wiring requirements in a vehicle.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for an on-board charger, the system comprising:
a battery charger including:
a direct current to direct current (DC-DC) converter connected to a power factor correction (PFC) subsystem, wherein the PFC subsystem includes one or more leaves,
wherein the one or more leaves of the PFC subsystem are operable to configure the PFC subsystem into each of a charging operation, a discharging operation, a split-phase operation, and a simultaneous charging and discharging operation.

2. The system of claim 1, wherein the on-board charger further includes:
a neutral half bridge connected to the one or more leaves;
a bypass relay connected to the one or more leaves and a power input; and
an alternating current (AC) electromagnetic interference (EMI) filter connected between the one or more leaves and the bypass relay.

3. The system of claim 1, wherein the one or more leaves include:
a first leaf including a first inductor, a first upper switch, and a first lower switch, the first inductor connected to the first upper switch and the first lower switch;
a second leaf including a second inductor, a second upper switch, and a second lower switch, the second inductor connected to the second upper switch and the second lower switch;
a third leaf including a third inductor, a third upper switch, and a third lower switch, the third inductor connected to the third upper switch and the third lower switch; and
a fourth leaf including a fourth inductor, a fourth upper switch, and a fourth lower switch, the fourth inductor connected to the fourth upper switch and the fourth lower switch.

4. The system of claim 3, wherein the charging operation is configured to activate the first leaf and the second leaf, and turn off a bypass relay to charge a battery connected to a first power input, wherein each of the first leaf and the second leaf are configured at 90 degree phase shifts.

5. The system of claim 4, wherein the charging operation includes a high power configuration operable to activate the first leaf, the second leaf, the third leaf, the fourth leaf, and turn on the bypass relay to charge the battery connected to the first power input,
wherein the first leaf, the second leaf, the third leaf, and the fourth leaf are configured at 90 degree phase shifts,
wherein the first leaf and the second leaf are connected in parallel and the third leaf and the fourth leaf are connected in parallel.

6. The system of claim 3, wherein the discharging operation is configured to activate the first leaf and the second leaf, and turn off a bypass relay to output AC power received from the DC-DC converter through a first output, wherein each of the first leaf and the second leaf are configured at 90 degree phase shifts.

7. The system of claim 6, wherein the discharging operation includes a high power configuration operable to activate the first leaf, the second leaf, the third leaf, the fourth leaf, and turn on the bypass relay to output AC power received from the DC-DC converter through the first output,
wherein the first leaf, the second leaf, the third leaf, and the fourth leaf are configured at 90 degree phase shifts,
wherein the first leaf and the second leaf are connected in parallel and the third leaf and the fourth leaf are connected in parallel.

8. The system of claim 3, wherein the split-phase operation configured to activate the first leaf and the second leaf to output AC power received from the DC-DC converter at a first output voltage and a second output voltage, wherein the first leaf and the second leaf are out-of-phase.

9. The system of claim 8, wherein the split-phase operation includes a high power configuration operable to activate the first leaf, the second leaf, the third leaf, and the fourth leaf to output AC power received from the DC-DC converter at the first output voltage and the second output voltage,
wherein the first leaf and the second leaf are combined and the third leaf and the fourth leaf are combined,
wherein the combined first leaf and the second leaf are connected in parallel and are out-of-phase with the combined third leaf and the fourth leaf connected in parallel.

10. The system of claim 3, wherein the simultaneous charging and discharging operation is configured to:
operate the first leaf and the second leaf to charge a battery connected to a first power input; and
operate the third leaf and the fourth leaf to output AC power received from the DC-DC converter through a first output.

11. The system of claim 1, further comprising:
a battery connected to the DC-DC converter of the battery charger, and
a motor configured to rotate based on power received from the battery,
wherein the system is provided as a vehicle.

12. The system of claim 10, wherein the battery charger is configured to:
receive input AC power through the PFC subsystem, convert the AC power to DC power, and provide the DC power to the battery to charge the battery, and
receive DC power from the battery through the DC-DC converter, convert the DC power to AC power, and provide the AC power through the PFC subsystem as output AC power.

13. A system for a power factor correction (PFC) subsystem, the system comprising:
a first leaf including a first inductor, a first upper switch, and a first lower switch, the first inductor connected to the first upper switch and the first lower switch; and
a second leaf including a second inductor, a second upper switch, and a second lower switch, the second inductor connected to the second upper switch and the second lower switch;
wherein the first leaf and the second leaf are connected to one or more AC EMI filters, a bypass relay, and one or more inputs.

14. The system of claim 13, further comprising:
a third leaf including a third inductor, a third upper switch, and a third lower switch, the third inductor connected to the third upper switch and the third lower switch; and
a fourth leaf including a fourth inductor, a fourth upper switch, and a fourth lower switch, the fourth inductor connected to the fourth upper switch and the fourth lower switch,
wherein the third leaf and the fourth leaf are connected to the one more AC EMI filters and the one or more inputs.

15. The system of claim 13, wherein the first leaf and the second leaf are operable to configure the PFC subsystem into each of a charging operation, a discharging operation, a split-phase operation, and a simultaneous charging and discharging operation.

16. The system of claim 15, wherein the charging operation is configured to charge a battery connected to a first input,
wherein the discharging operation is configured to output AC power through a first output,
wherein the split-phase operation is configured to output AC power at a first output voltage and a second output voltage, and
wherein the simultaneous charging and discharging operation is configured to charge the battery connected to the first input and output AC power through the first output.

17. A method comprising:
operating a first leaf and a second leaf of a PFC subsystem to perform a charging operation, wherein the charging operation is configured to charge a battery connected to a DC-DC converter;
operating the first leaf and the second leaf of the PFC subsystem to perform a discharging operation, wherein the discharging operation is configured to output AC power received from the DC-DC converter;
operating the first leaf and the second leaf of the PFC subsystem to perform a split-phase operation, wherein the split-phase operation is configured to output out-of-phase AC power received from the DC-DC converter; and
operating the first leaf, the second leaf, a third leaf, and a fourth leaf of the PFC subsystem to perform a simultaneous charging and discharging operation, wherein the simultaneous charging and discharging operation is configured to charge a battery connected to the DC-DC converter and output AC power received from the DC-DC converter.

18. The method of claim 17, wherein the charging operation further includes activating the first leaf and the second leaf, and turning off a bypass relay to charge the battery connected to a first power input, wherein each of the first leaf and the second leaf are configured at 90 degree phase shifts,
wherein the discharging operation further includes activating the first leaf and the second leaf, and turn off the bypass relay to output AC power received from the DC-DC converter through a first output, wherein each of the first leaf and the second leaf are configured at 90 degree phase shifts,
wherein the split-phase operation further includes activating the first leaf and the second leaf to output the AC power received from the DC-DC converter at a first output voltage and a second output voltage, wherein the first leaf and the second leaf are out-of-phase, and
wherein the simultaneous charging and discharging operation further includes operating the first leaf and the second leaf to charge the battery connected to the first power input and operate the third leaf and the fourth leaf to output the AC power received from the DC-DC converter through the first output.

19. The method of claim 18, wherein the charging operation further includes operating the third leaf, the fourth leaf, and turning on the bypass relay to charge the battery connected to the first power input, wherein the first leaf, the second leaf, the third leaf, and the fourth leaf are configured at 90 degree phase shifts, wherein the first leaf and the second leaf are connected in parallel and the third leaf and the fourth leaf are connected in parallel.

20. The method of claim 18, wherein the discharging operation further includes operating the third leaf, the fourth leaf, and turning on the bypass relay to output AC power received from the DC-DC converter through a first output, wherein the first leaf, the second leaf, the third leaf, and the fourth leaf are configured at 90 degree phase shifts, wherein the first leaf and the second leaf are connected in parallel and the third leaf and the fourth leaf are connected in parallel.
